(19) United States
(12) Patent Application Publication
(10) Pub. No.: US 2024/0218123 A1
(43) Pub. Date: Jul. 4, 2024

(54) BIFUNCTIONAL SIZING AGENT FOR IMPROVED ADHESION TO SUBSTRATES

(71) Applicant: SHPP GLOBAL TECHNOLOGIES B.V., Bergen op Zoom (NL)

(72) Inventors: Timothy Edward Banach, Scotia, NY (US); Eylem Tarkin-Tas, Delmar, NY (US)

(21) Appl. No.: 18/286,951

(22) PCT Filed: Apr. 26, 2022
(86) PCT No.: PCT/IB2022/053860

§ 371 Date: Oct. 13, 2023

(30) Foreign Application Priority Data
Apr. 27, 2021 (EP) 21170719.5

(51) Int. Cl. C08G 65/48; C08F 283/08; C08L 71/12

(52) U.S. Cl. CPC C08G 65/485; C08F 283/085; C08L 71/126; C08F 2810/20; C08F 2810/30; C08L 2205/025

(57) ABSTRACT

A composition comprising a sizing agent comprising a bifunctional poly(arylene ether) comprising a silyl-containing group comprising a silyl-containing terminal group, a silyl-containing pendant group, or a combination thereof; and optionally comprising a terminal functional group, wherein the terminal functional group is not a silyl-containing terminal group or hydrogen.

### CROSS-REFERENCE TO RELATED APPLICATION

This PCT application claims priority to European Application No. 21170719.5, filed Apr. 27, 2021, the content of which is herein incorporated by reference in its entirety.

### BACKGROUND

This disclosure relates to sizing agents, and in particular to bifunctional sizing agents, compositions including sizing agents, methods of manufacture, and uses thereof.

Thermosetting resins are materials that cure to form very hard plastics. These materials that may be used in a wide variety of consumer and industrial products. For example, thermosets are used in protective coatings, adhesives, electronic laminates (such as those used in the fabrication of computer circuit boards), flooring, and paving applications, glass fiber-reinforced pipes, and automotive parts (including leaf springs, pumps, and electrical components). Poly(arylene ether)s generally have good dielectric properties. Because of their broad use, particularly in electronic applications, such as laminates for printed circuit boards, it is desirable to provide compositions including poly(arylene ether)s with improved adhesion to substrates such as copper foil substrates of multi-layer laminates.

There accordingly remains a need in the art for poly(arylene ether) compositions with improved adhesion to substrates such as copper foil substrates of multi-layer laminates.

### BRIEF DESCRIPTION

The above-described and other deficiencies of the art are met by a composition comprising a composition comprising a sizing agent comprising a bifunctional poly(arylene ether) comprising a silyl-containing group comprising a silyl-containing terminal group, a silyl-containing pendant group, or a combination thereof; and optionally comprising a terminal functional group, wherein the terminal functional group is not a silyl-containing terminal group or hydrogen.

In another aspect, methods of manufacture comprise combining the above-described components to form the sizing agent.

In another aspect, a curable composition comprises the above-described composition.

In another aspect, a thermoset comprises the curable composition.

In another aspect, a method of forming a coated substrate comprises coating a substrate with the above-described composition.

In yet another aspect, an article comprises the thermoset.

In still another aspect, a method of manufacture of an article comprises molding, extruding, or shaping the above-described poly(arylene ether) into an article.

In still another aspect, a reinforcing agent sized with the above-described composition is disclosed.

In still another aspect, a metallic foil coated with the above-described composition is disclosed

The above described and other features are exemplified by the following detailed description, examples, and claims.

### DETAILED DESCRIPTION

Poly(arylene ether)s have been known to improve the dielectric performance of thermosetting materials for electronics applications. Demand for big data storage and high speed data transmission at higher frequencies has increased the requirement for use of high density and multilayer printed circuit boards in electronics applications. Increase in the complexity of the boards, reduction in design space along with introduction of radio units has increased the demand for high performance materials.

Printed circuit boards (PCBs) may include a sheet of thermoset resin and a layer of copper foil, laminated to a substrate. PCBs may have multiple copper layers. For example, a two-layer board may have copper on both sides of a layer of thermoset resin and multi-layer boards may sandwich additional copper layers between layers of thermoset resin. At high frequencies, the current tends to follow the contour of the surface of the conductor (e.g., copper foil), leading to signal loss (i.e., “skin effect”). Therefore, in order to reduce overall insertion loss or the losses due to conductors, smoother conductor (e.g., metallic) surfaces, also referred to as “low-profile” surfaces, are preferred. High performance materials that may adhere to smooth metallic foils in multilayer printed circuit boards could potentially increase the transmission speed by reducing the dielectric loss. However, conventional poly(arylene ether) laminates may not readily adhere to smooth metallic surfaces, such as the surface of a low-profile copper foil. Advantageously, the inventors hereof have discovered a bifunctional sizing agent that may promote adhesion to smooth metallic surfaces, that is soluble in the poly(arylene ether) matrix, and that may participate in crosslinking. By incorporating the bifunctional sizing agent into the poly(arylene ether) compositions, this could potentially avoid post-manufacturing surface modification, thus reducing manufacturing costs. The sizing agent includes a bifunctional poly(arylene ether) including a silyl-containing group and optionally, a terminal functional group other than a silyl-containing group or hydrogen. The silyl-containing group may be present as a terminal functional group, a pendant group, or a combination of a terminal functional group and a pendant group. Thus, the silyl-containing groups, whether pendant groups or a terminal group, promote adhesion to the surface. When the silyl-containing group is present only as a pendant group, both hydroxyl-termini are available for functionalization and crosslinking. When the silyl-containing group is present as a terminal group and optionally as a pendant group, one hydroxyl-terminus is available for functionalization and cross-linking. This is unlike conventional poly(arylene ether)s having silyl-containing terminal groups, in which both termini of the poly(arylene ether) include silyl-containing groups because the present approach allows for one terminus to be available for crosslinking. The compositions may further include an auxiliary bifunctional poly(arylene ether) with an optional terminal functional group. The bifunctional sizing agent may be used for surface treatment of substrates, the example, glass fiber, alumina fiber, basalt fiber, quartz fiber, inorganic filler, and metal foil.

The compositions include a sizing agent and optionally an auxiliary bifunctional poly(arylene ether).

The sizing agent of the compositions include a bifunctional poly(arylene ether) that includes a silyl-containing group and optionally, a terminal functional group. The silyl-containing group may include a silyl-containing terminal group, a silyl-containing pendant group, or a combination of a silyl-containing terminal group and a silyl-containing pendant group. The optional terminal functional group is not a silyl-containing terminal group or hydrogen.

The compositions may include an auxiliary bifunctional poly(arylene ether) in addition to the bifunctional poly(arylene ether) of the sizing agent. The auxiliary bifunctional poly(arylene ether) may include a terminal functional group. The optional terminal functional group of the bifunctional poly(arylene ether) is not a silyl-containing terminal group or hydrogen.

The individual components of the compositions are discussed in more detail below.

The poly(arylene ether) of the sizing agent and/or the auxiliary bifunctional poly(arylene ether) may include repeating units derived from a monohydric phenol. The repeating units derived from the monohydric phenol comprise the formula (1)

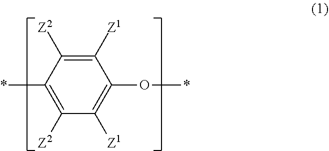

wherein each occurrence of Z¹ independently comprises halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² independently comprises hydrogen, halogen, unsubstituted or substituted C₁-C₁₂ hydrocarbyl provided that the hydrocarbyl group is not tertiary hydrocarbyl, C₁-C₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen.

The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue may also contain one or more carbonyl groups, amino groups, hydroxyl groups, or the like, or it may contain heteroatoms within the backbone of the hydrocarbyl residue. As one example, Z¹ may be a di-n-butylaminomethyl group formed by reaction of a terminal 3,5-dimethyl-1,4-phenyl group with the di-n-butylamine component of an oxidative polymerization catalyst.

The poly(arylene ether) of the sizing agent and/or the auxiliary monofunctional or bifunctional poly(arylene ether) may include 2,6-dimethyl-1,4-phenylene ether units, 2,3,6-trimethyl-1.4-phenylene ether units, or a combination thereof. In some aspects, the poly(arylene ether) is a poly(2.6-dimethyl-1,4-phenylene ether). In some aspects, the poly(arylene ether) comprises a poly(2,6-dimethyl-1,4-phenylene ether) having an intrinsic viscosity of 0.03 to 1 deciliter per gram. For example, the poly(arylene ether) may have an intrinsic viscosity of 0.25 to 1 deciliter per gram, specifically 0.25 to 0.7 deciliter per gram, more specifically 0.35 to 0.55 deciliter per gram, even more specifically 0.35 to 0.50 deciliter per gram, measured at 25° C. in chloroform using an Ubbelohde viscometer.

The poly(arylene ether) of the sizing agent and/or the auxiliary bifunctional poly(arylene ether) may include molecules having aminoalkyl-containing end group(s), typically located in a position ortho to the hydroxy group. Also frequently present are tetramethyldiphenoquinone (TMDQ) end groups, typically obtained from 2.6-dimethylphenol-containing reaction mixtures in which tetramethyldiphenoquinone by-product is present. The poly(arylene ether) may be in the form of a homopolymer, a copolymer, a graft copolymer, an ionomer, a block copolymer, or an oligomer as well as combinations thereof.

The poly(arylene ether) of the sizing agent and/or the auxiliary bifunctional poly(arylene ether) may include a poly(arylene ether) of formula (2)

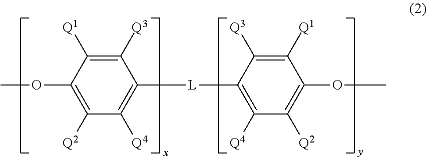

wherein each occurrence of Q¹ and Q² independently comprises halogen, unsubstituted or substituted C₁₋₁₅ primary or secondary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; each occurrence of Q³ and Q⁴ independently comprises hydrogen, halogen, unsubstituted or substituted C₁-C₁₅ primary or secondary hydrocarbyl, C₁-C₂ hydrocarbylthio, C₁₋₁₂ hydrocarbyloxy, or C₂₋₁₂ halohydrocarbyloxy wherein at least two carbon atoms separate the halogen and oxygen atoms; x and y have an average value, and are each independently 0-30, or 0-20, preferably 0-15, still more preferably 0-10, even more preferably 0-8, provided that the sum of x and y is at least 2, preferably at least 3, more preferably at least 4; wherein at least one of Q¹ to Q⁴, or a combination thereof is unsubstituted or substituted C₁₋₁₅ primary or secondary hydrocarbyl. In an aspect, Q¹, Q², Q³, or Q⁴ is hydrogen, methyl, cyclohexyl, phenyl, di-n-butylaminomethyl, or morpholinomethyl, or a combination thereof.

Further in formula (2). L is of formula (3) or formula (4) as described below. L may be of formula (3)

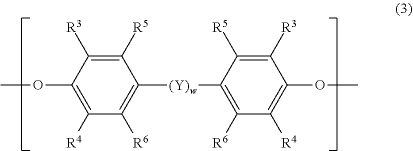

wherein each occurrence of R³, R⁴, R⁵, and R⁶ independently comprises hydrogen, halogen, unsubstituted or substituted C₁₋₁₂ primary or secondary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; w is 0 or 1; and Y is

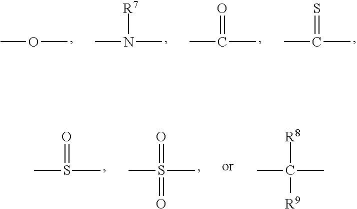

wherein each occurrence of R⁷ independently comprises hydrogen or C₁₋₁₂ hydrocarbyl, each occurrence of R⁸ and R⁹ independently comprises hydrogen, C₁₋₁₂ hydrocarbyl, or R⁸ and R⁹ together form a C₄₋₁₂ cyclohydrocarbylene with the carbon atom. In an aspect in formula (3), each of R³, R⁴, R⁵, and R⁶ independently comprises hydrogen, halogen, unsubstituted or substituted C₁₋₆ primary or secondary hydrocarbyl; and w is 0 or 1.

In another aspect, L in formula (2) is of formula (4)

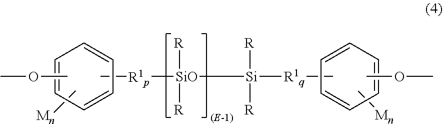

wherein E is 6-100, or 11-80, or 11-60; and each occurrence of R independently comprises an unsubstituted or substituted C₁₋₁₃ alkyl, C₁₋₁₃ alkoxy, C₃₋₆ cycloalkyl, C₃₋₆ cycloalkoxy, C₆₋₁₄ aryl, C₆₋₁₀ aryloxy, C₇₋₁₃ arylalkylene, or C₇₋₁₃ alkylarylene. The foregoing groups may be fully or partially halogenated with fluorine, chlorine, bromine, or iodine, or a combination thereof. Further in formula (4), each p and q are independently 0 or 1: R¹ is a divalent C₂₋₈ aliphatic group, and each occurrence of M independently comprises halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₂ alkylaryl, or C₇₋₁₂ alkylaryloxy, wherein each n independently comprises 0, 1, 2, 3, or 4. Preferably in formula 4, E is 5-60: each occurrence of R independently comprises C₁₋₆ alkyl, C₃₋₆ cycloalkyl, or C₆₋₁₄ aryl, more preferably methyl; p and q are each 1; R¹ is a divalent C₂₋₈ aliphatic group, M is halogen, cyano, C₁₋₄ alkyl, C₁₋₄ alkoxy, C₆₋₁₀ aryl, C₇₋₁₂ aralkyl, or C₇₋₁₂ alkylaryl, more preferably methyl or methoxy; and each n independently comprises 0, 1, or 2.

In some aspects the poly(arylene ether) of the sizing agent and/or the auxiliary poly(arylene ether) comprises a poly(arylene ether) of formula (2b)

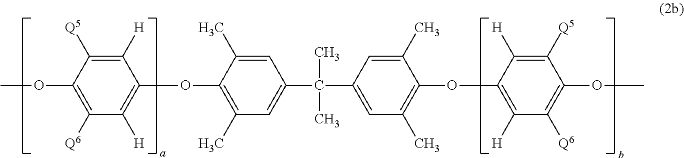

wherein each occurrence of Q and Qu independently comprises methyl, di-n-butylaminomethyl, or morpholinomethyl; and each occurrence of a and b is independently 0 to 20, with the proviso that the sum of a and b is at least 2.

The poly(arylene ether)s of formula (2) may be prepared by derivatization of a hydroxyl-terminated poly(arylene ether) prepared by oxidative polymerization of at least one monohydric phenol, optionally in combination with at least one dihydric or polyhydric phenol, in the presence of a polymerization catalyst comprising a catalyst metal ion and a catalyst amine ligand, oxygen, and solvent. The polymerization catalyst may be prepared in situ by mixing the catalyst metal ion and the catalyst amine ligand. The solvent may be benzene, toluene, xylenes, mesitylene, chlorobenzene, dichlorobenzenes, chloroform, or combinations thereof. In some aspects, the solvent comprises toluene. The molecular oxygen may be provided, for example, in a purified form or as air.

As used herein, the term “poly(arylene ether)” may also refer to lower molecular weight poly(arylene ether)s. In some aspects, the poly(arylene ether) comprises 2,6-dimethyl-1,4-phenylene ether units, 2,3,6-trimethyl-1,4-phenylene ether units, or a combination thereof. In some aspects, the poly(arylene ether) may have an intrinsic viscosity of 0.03 to 0.13 deciliter per gram, or 0.05 to 0.1 deciliter per gram, or 0.1 to 0.15 deciliter per gram, measured at 25° C. in chloroform using an Ubbelohde viscometer. The poly(arylene ether) may have a number average molecular weight of 500 to 7,000 grams per mole, and a weight average molecular weight of 500 to 15,000 grams per mole, as determined by gel permeation chromatography using polystyrene standards. In some aspects, the number average molecular weight may be 750 to 4,000 grams per mole, and the weight average molecular weight may be 1,500 to 9,000 grams per mole, as determined by gel permeation chromatography using polystyrene standards.

In some aspects, the poly(arylene ether) is essentially free of incorporated diphenoquinone residues. In the context, “essentially free” means that the less than 1 weight percent (wt %) of poly(arylene ether) molecules comprise the residue of a diphenoquinone. As described in U.S. Pat. No. 3,306,874 to Hay, synthesis of poly(arylene ether) by oxidative polymerization of monohydric phenol yields not only the desired poly(arylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(arylene ether) (i.e., the diphenoquinone is incorporated into the poly(arylene ether) structure) by heating the polymerization reaction mixture to yield a poly(arylene ether) comprising terminal or internal diphenoquinone residues. For example, when a poly(arylene ether) is prepared by oxidative polymerization of 2,6-dimethylphenol to yield poly(2.6-dimethyl-1,4-phenylene ether) and 3,3′,5,5′-tetramethyldiphenoquinone, reequilibration of the reaction mixture may produce a poly(arylene ether) with terminal and internal residues of incorporated diphenoquinone. However, such reequilibration reduces the molecular weight of the poly(arylene ether). Accordingly, when a higher molecular weight poly(arylene ether) is desired, it may be desirable to separate the diphenoquinone from the poly(arylene ether) rather than reequilibrating the diphenoquinone into the poly(arylene ether) chains. Such a separation may be achieved, for example, by precipitation of the poly(arylene ether) in a solvent or solvent mixture in which the poly(arylene ether) is insoluble and the diphenoquinone is soluble. For example, when a poly(arylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone may be obtained by mixing 1 volume of the toluene solution with 1-4 volumes of methanol or a methanol/water mixture. Alternatively, the amount of diphenoquinone side-product generated during oxidative polymerization may be minimized (e.g., by initiating oxidative polymerization in the presence of less than 10 wt % of the monohydric phenol and adding at least 95 wt % of the monohydric phenol over the course of at least 50 minutes), and/or the reequilibration of the diphenoquinone into the poly(arylene ether) chain may be minimized (e.g., by isolating the poly(arylene ether) no more than 200 minutes after termination of oxidative polymerization). These approaches are described in International Patent Application Publication No. WO2009/104107 A1 of Delsman et al. In an alternative approach using the temperature-dependent solubility of diphenoquinone in toluene, a toluene solution containing diphenoquinone and poly(arylene ether) may be adjusted to a temperature of 25° C., at which diphenoquinone is poorly soluble but the poly(arylene ether) is soluble, and the insoluble diphenoquinone may be removed by solid-liquid separation (e.g., filtration).

The poly(arylene ether) of the sizing agent includes a silyl-containing group, and optionally includes a terminal functional group that is not a silyl-containing group or hydrogen. The silyl-containing group of the sizing agent may include a silyl-containing terminal group, a silyl-containing pendant group, or the silyl-containing group of the sizing agent may be present as both a silyl-containing terminal group and a silyl-containing pendant group. The silyl-containing group that is a pendant group includes the formula (CR₂)ₙSi(Rₐ)(OR)₃₋ₐ. In some aspects, the silyl-containing group that is a pendant group includes the formula *—(CR₂)ₙSi(Rₐ)(OR)₃₋ₐ, wherein the silyl-containing pendant group is derived from a repeating unit comprising the formula

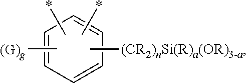

/where “*” indicates attachment of the pendant group to the backbone (i.e., main chain) of the poly(arylene ether). The silyl-containing group that is a terminal functional group includes the following formula

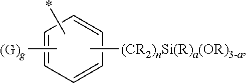

where “*” indicates attachment of the terminal functional group to the poly(arylene ether). Referring to the silyl-containing pendant group and the silyl-containing terminal group of the sizing agent, each occurrence of R is independently hydrocarbyl, a is 0 to 2, n is 2 to 13, g is 0 to 4, each occurrence of G is halogen, unsubstituted or substituted C₁₋₁₅ primary or secondary hydrocarbyl, C₁₋₁₅ hydrocarbylthio, C₁₋₁₅ hydrocarbyloxy, or C₂₋₁₅ halohydrocarbyloxy wherein at least two carbon atoms separate the halogen and oxygen atoms. The silyl-containing groups may be the same or different.

When the silyl-containing group is a terminal functional group, the silyl-containing group may be incorporated as shown in formula S-1. When the silyl-containing group is a pendant group, the silyl-containing group may be incorporated as shown in formula S-2. When the silyl-containing group is a pendant group and a terminal functional group, the silyl-containing groups may be incorporated as shown in formula S-3. The poly(arylene ether)s shown below are not so limited, but included for illustration purposes only.

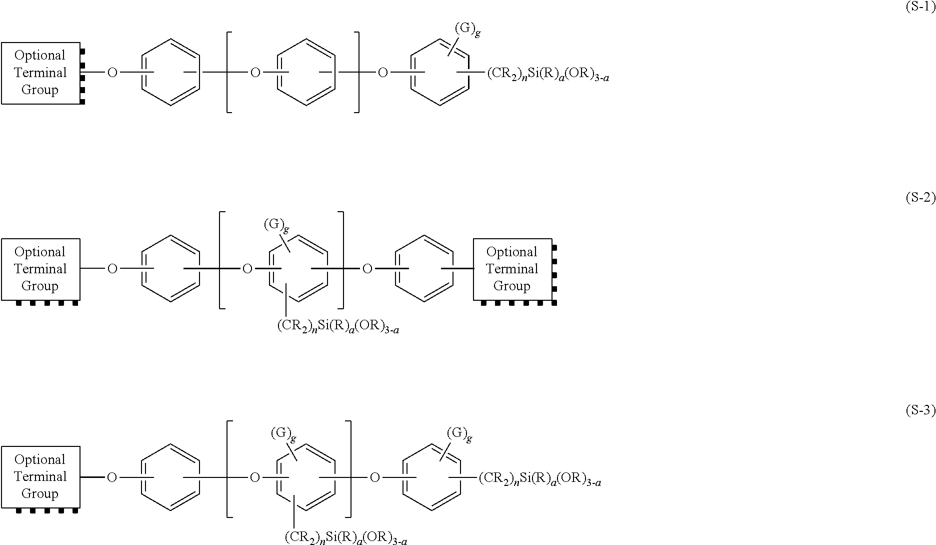

Referring to formulas S-1 to S-3, each occurrence of G, g, R, a, and n are as described above. Each occurrence of G, g, R, a, and n may be the same or different.

Each of the bifunctional poly(arylene ether) of the sizing agent and the auxiliary monofunctional or bifunctional poly(arylene ether) may include a terminal functional group. The terminal functional group of the poly(arylene ether) of the sizing agent is a group other than a silyl-containing group or hydrogen. Similarly, the auxiliary poly(arylene ether) may include at least one terminal functional group that is not a silyl-containing group or hydrogen.

In an aspect, the auxiliary poly(arylene ether) comprises a bifunctional poly(arylene ether) having the structure

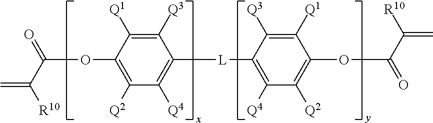

wherein Q¹, Q², Q³, Q⁴, L, x and y are as defined above R¹⁰ is methyl or hydrogen.

In the (meth)acrylate-terminated poly(arylene ether) structure above, there are limitations on the variables x and y, which correspond to the number of phenylene ether repeating units at two different places in the bifunctional poly(arylene ether). In the structure, x and y are independently 0 to 30, specifically 0 to 20, more specifically 0 to 15, even more specifically 0 to 10, yet more specifically 0 to 8. The sum of x and y is at least 2, specifically at least 3, more specifically at least 4. A poly(arylene ether) may be analyzed by proton nuclear magnetic resonance spectroscopy (¹H NMR) to determine whether these limitations are met, on average. Specifically. ¹H NMR may distinguish between protons associated with internal and terminal phenylene ether groups, with internal and terminal residues of a polyhydric phenol, and with terminal residues as well. It is therefore possible to determine the average number of phenylene ether repeating units per molecule, and the relative abundance of internal and terminal residues derived from dihydric phenol.

In some aspects, the auxiliary poly(arylene ether) comprises a bifunctional poly(arylene ether) having the structure

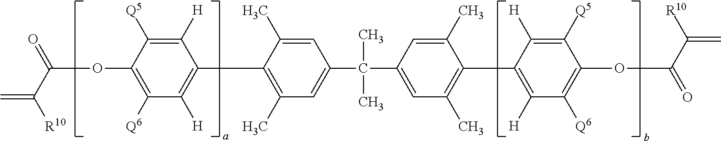

wherein each occurrence of Q⁵ and Q⁶ independently comprises methyl, di-n-butylaminomethyl, or morpholinomethyl; and each occurrence of a and b is independently 0 to 20, with the proviso that the sum of a and b is at least 2; and each occurrence of R¹⁰ is methyl or hydrogen.

The bifunctional poly(arylene ether) of the sizing agent and/or the auxiliary monofunctional or bifunctional poly(arylene ether) may include a terminal functional group. The terminal functional groups may include (meth)acrylate, styrene, —CH₂—(C₆H₄)—CH═CH₂, allyl, cyanate ester, glycidyl ether, anhydride, aniline, maleimide, an activated ester, or a combination thereof.

The sizing agent may be prepared according to a method including the following steps: oxidatively polymerizing a monohydric phenol, an alkenyl-substituted monohydric phenol, and optionally a dihydric phenol to provide a sizing agent precursor having an alkenyl pendant group, an alkenyl-substituted phenolic terminal functional group, or a combination thereof, and a bifunctional poly(arylene ether) having hydroxyl terminuses, reacting the alkenyl group of the sizing agent precursor with a silane reagent to provide a sizing agent having a silyl-containing terminal group, a silyl-containing pendant group, or a combination thereof, and at least one hydroxyl terminus, and optionally reacting the at least one hydroxyl terminus of the sizing agent to provide a sizing agent having a silyl-containing terminal group, a silyl-containing pendant group, or a combination thereof and a terminal functional group, wherein the terminal functional group is not a silyl-containing terminal group or hydrogen, and optionally reacting an at least one hydroxyl terminus of the bifunctional poly(arylene ether) to provide a bifunctional poly(arylene ether) having the at least one terminal functional group. The scheme below shows examples sizing agent precursors (P-1 to P-3), wherein the alkenyl-substituted monohydric phenol incorporated into the backbone of the poly(arylene ether), incorporated as a terminal functional group, or both. The structures and the scheme below is for illustration purposes only and the compositions and methods of the disclosure are not so limited.

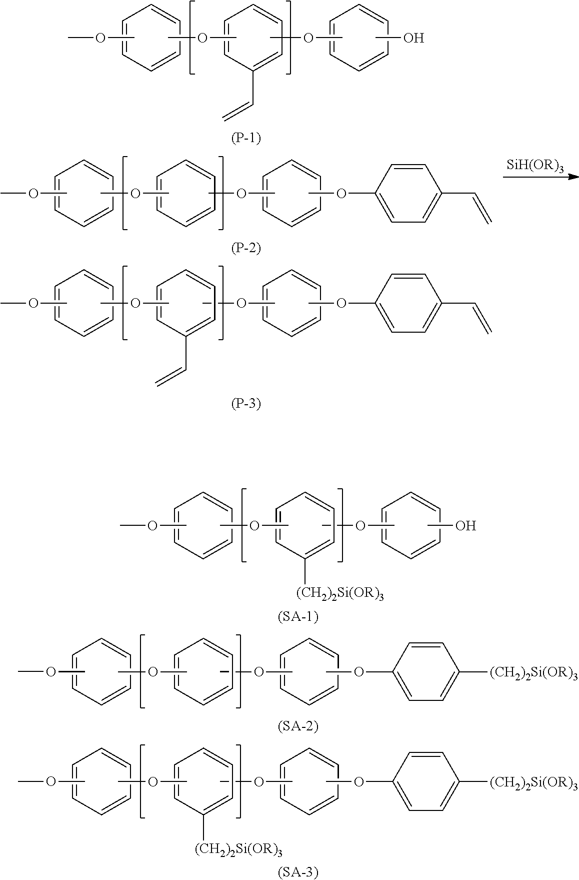

The sizing agent may be prepared using redistribution methods. The poly(arylene ether) used in the redistribution methods may be monofunctional or bifunctional. The silyl-containing group may be incorporated before or after redistribution. For example, an alkenyl-substituted monohydric phenol may be added to the redistribution reaction mixture and after redistribution is completed, then the alkenyl group may be converted to a silyl-containing group. Alternatively, the alkenyl group of the alkenyl-substituted monohydric phenol may converted to a silyl group prior to redistribution.

Redistribution methods may include the following steps: adding a redistribution catalyst to a reaction mixture comprising an alkenyl-substituted monohydric phenol and a monofunctional or bifunctional poly(arylene ether) precursor having a hydroxyl terminus to provide a sizing agent oligomeric precursor having an alkenyl-substituted phenolic terminal functional group and a monofunctional or bifunctional poly(arylene ether) having a hydroxyl terminus, reacting the alkenyl group of the sizing agent oligomeric precursor with a silane reagent to provide a sizing agent having a hydroxyl terminus and a silyl-containing terminal group, and optionally reacting the hydroxyl terminus of the sizing agent oligomeric precursor to provide a sizing agent having a silyl-containing terminal group and a terminal functional group, wherein the terminal functional group is not a silyl-containing terminal group or hydrogen, and optionally reacting the hydroxyl terminus of the monofunctional or bifunctional poly(arylene ether) to provide a bifunctional poly(arylene ether) having a terminal functional group.

Redistribution methods may include the following steps: adding a redistribution catalyst to a reaction mixture comprising an silyl-substituted monohydric phenol and a monofunctional or bifunctional poly(arylene ether) precursor having a hydroxyl terminus to provide a sizing agent oligomeric precursor having a silyl-substituted phenolic terminal functional group and a monofunctional or bifunctional poly(arylene ether) having a hydroxyl terminus, and optionally reacting the hydroxyl terminus of the sizing agent oligomeric precursor to provide a sizing agent having a silyl-containing terminal group and a terminal functional group, wherein the terminal functional group is not a silyl-containing terminal group or hydrogen, and optionally reacting the hydroxyl terminus of the monofunctional or bifunctional poly(arylene ether) to provide a monofunctional or bifunctional poly(arylene ether) having a terminal functional group.

As disclosed above, the bifunctional poly(arylene ether) of the sizing agent and the auxiliary monofunctional or bifunctional poly(arylene ether) may have at least one terminal functional group, and the method of making each of the poly(arylene ether) further comprises reacting the poly(arylene ether) having terminal hydroxyl groups with a compound to provide a poly(arylene ether) having at least one (meth)acrylate, styrene, —CH₂—(C₆H₄)—CH═CH₂, allyl, cyanate ester, glycidyl ether, anhydride, aniline, maleimide, or activated ester terminal functional groups. For example, when a poly(arylene ether) having at least one vinyl benzyl ether end group is desired, the method may comprise reacting the hydroxyl-terminated poly(arylene ether) with a vinyl benzyl halide (e.g., vinyl benzyl chloride). When a functional phenylene ether having at least one (meth)acrylic end group is desired, the method may comprise reacting the hydroxyl-terminated poly(arylene ether) with a (meth)acrylic acid halide or a (meth)acrylic anhydride. Suitable compounds comprising the desired functional groups and a group reactive toward the poly(arylene ether) having terminal hydroxyl groups may be readily determined by one skilled in the art.

The poly(arylene ether)s of the present disclosure may be reactive components in curable compositions. In the curable compositions, the bifunctional poly(arylene ether) of the sizing agent and the auxiliary monofunctional or bifunctional poly(arylene ether) each include a terminal functional group. In addition to the sizing agent and the auxiliary bifunctional poly(arylene ether), the curable compositions may include a curing promoter. A curing promoter may be selected based on the functional group present on the poly(arylene ether) and, when present, the auxiliary curable resin or the curable unsaturated monomer composition. For example, the curing promoter may comprise an amine, a dicyandiamide, a polyamide, an amidoamine, a Mannich base, an anhydride, a phenol-formaldehyde resin, a carboxylic acid functional polyester, a polysulfide, a polymercaptan, an isocyanate, a cyanate ester, or a combination thereof.

In some aspects, the curable composition may further include an auxiliary curable resin, a curable unsaturated monomer or polymer composition, or both. The auxiliary curable resin may be a thermoset resin, for example, an epoxy resin, a cyanate ester resin, an isocyanate resin, a maleimide resin, a benzoxazine resin, a vinylbenzyl ether resin, an arylcyclobutene resin, a perfluorovinyl ether resin, oligomers or polymers with curable vinyl functionality, or a combination thereof.

Epoxy resins useful as auxiliary curable resins may be produced by reaction of phenols or polyphenols with epichlorohydrin to form polyglycidyl ethers. Examples of useful phenols for production of epoxy resins include substituted bisphenol A, bisphenol F, hydroquinone, resorcinol, tris-(4-hydroxyphenyl)methane, and novolac resins derived from phenol or o-cresol. Epoxy resins may also be produced by reaction of aromatic amines, such as p-aminophenol or methylenedianiline, with epichlorohydrin to form polyglycidyl amines. Epoxy resins may be converted into solid, infusible, and insoluble three dimensional networks by curing with cross-linkers, often called curing agents, or hardeners. Curing agents are either catalytic or coreactive. Coreactive curing agents have active hydrogen atoms that may react with epoxy groups of the epoxy resin to form a cross-linked resin. The active hydrogen atoms may be present in functional groups comprising primary or secondary amines, phenols, thiols, carboxylic acids, or carboxylic acid anhydrides. Examples of coreactive curing agents for epoxy resins include aliphatic and cycloaliphatic amines and amine-functional adducts with epoxy resins, Mannich bases, aromatic amines, polyamides, amidoamines, phenalkamines, dicyandiamide, polycarboxylic acid-functional polyesters, carboxylic acid anhydrides, amine-formaldehyde resins, phenol-formaldehyde resins, polysulfides, polymercaptans, or a combination thereof coreactive curing agents. A catalytic curing agent functions as an initiator for epoxy resin homopolymerization or as an accelerator for coreactive curing agents. Examples of catalytic curing agents include tertiary amines, such as 2-ethyl-4-methylimidazole, Lewis acids, such as boron trifluoride, and latent cationic cure catalysts, such as diaryliodonium salts.

The auxiliary curable resin may be a cyanate ester. Cyanate esters are compounds having a cyanate group (—O—C═N) bonded to carbon via the oxygen atom, i.e. compounds with C—O—C═N groups. Cyanate esters useful as auxiliary curable resins may be produced by reaction of a cyanogen halide with a phenol or substituted phenol. Examples of useful phenols include bisphenols utilized in the production of epoxy resins, such as bisphenol A, bisphenol F, and novolac resins based on phenol or o-cresol. Cyanate ester prepolymers are prepared by polymerization/cyclotrimerization of cyanate esters. Prepolymers prepared from cyanate esters and diamines may also be used.

The auxiliary curable resin may be a bismaleimide resin. Bismaleimide resins may be produced by reaction of a monomeric bismaleimide with a nucleophile such as a diamine, aminophenol, or amino benzhydrazide, or by reaction of a bismaleimide with diallyl bisphenol A. Non-limiting examples of bismaleimide resins may include 1,2-bismaleimidoethane, 1,6-bismaleimidohexane, 1,3-bismaleimidobenzene, 1,4-bismaleimidobenzene, 2,4-bismaleimidotoluene, 4,4′-bismaleimidodiphenylmethane, 4,4′-bismaleimidodiphenylether, 3,3′-bismaleimidodiphenylsulfone, 4,4′-bismaleimidodiphenylsulfone, 4,4′-bismaleimidodicyclohexylmethane. 3,5-bis(4-maleimidophenyl)pyridine, 2.6-bismaleimidopyridine, 1,3-bis(maleimidomethyl)cyclohexane, 1,3-bis(maleimidomethyl)benzene, 1,1-bis(4-maleimidophenyl)cyclohexane, 1,3-bis(dichloromaleimido)benzene, 4,4′-bis(citraconimido)diphenylmethane, 2,2-bis(4-maleimidophenyl)propane, 1-phenyl-1,1-bis(4-maleimidophenyl)ethane, N,N-bis(4-maleimidophenyl)toluene, 3,5-bismaleimido-1,2,4-triazole N,N′-ethylenebismaleimide, N,N′-hexamethylenebismaleimide, N,N′-m-phenylenebismaleimide, N,N′-p-phenylenebismaleimide, N,N′-4,4′-diphenylmethanebismaleimide, N,N′-4,4′-diphenyletherbismaleimide, N,N′-4,4′-diphenylsufonebismaleimide, N,N′-4,4′-dicyclohexylmethanebismaleimide, N,N′-.alpha,alpha′-4,4′-dimethylenecyclohexanebismaleimide, N,N′-m-methaxylenebismaleimide, N,N′-4.4′-diphenylcyclohexanebismaleimide, and N,N′-methylenebis(3-chloro-p-phenylene)bismaleimide, as well as the maleimide resins disclosed in U.S. Pat. No. 3,562,223 to Bargain et al., and 4,211,860 and 4,211,861 to Stenzenberger. Bismaleimide resins may be prepared by methods known in the art, as described, for example, in U.S. Pat. No. 3,018,290 to Sauters et al. In some aspects, the bismaleimide resin is N,N′-4,4′-diphenylmethane bismaleimide.

The auxiliary curable resin may be a benzoxazine resin. As is well known, benzoxazine monomers are made from the reaction of three reactants, aldehydes, phenols, and primary amines with or without solvent. U.S. Pat. No. 5,543,516 to Ishida describes a solvent-free method of forming benzoxazine monomers. An article by Ning and Ishida in Journal of Polymer Science, Chemistry Edition, vol, 32, page 1121 (1994) describes a procedure using a solvent. The procedure using solvent is generally common to the literature of benzoxazine monomers.

The preferred phenolic compounds for forming benzoxazines include phenols and polyphenols. The use of polyphenols with two or more hydroxyl groups reactive in forming benzoxazines may result in branched or crosslinked products. The groups connecting the phenolic groups into a phenol may be branch points or connecting groups in the polybenzoxazine.

Exemplary phenols for use in the preparation of benzoxazine monomers include phenol, cresol, resorcinol, catechol, hydroquinone, 2-allylphenol, 3-allylphenol, 4-allylphenol, 2,6-dihydroxynaphthalene, 2,7-dihydrooxynapthalene, 2-(diphenylphosphoryl)hydroquinone, 2,2′-biphenol, 4,4-biphenol, 4,4′-isopropylidenediphenol (bisphenol A), 4,4′-isopropylidenebis(2-methylphenol), 4,4′-isopropylidenebis(2-allylphenol), 4,4′(1,3-phenylenediisopropylidene)bisphenol (bisphenol M), 4,4′-isopropylidenebis(3-phenylphenol) 4,4′-(1,4-phenylenediisoproylidene)bisphenol (bisphenol P), 4,4′-ethylidenediphenol (bisphenol E), 4,4′oxydiphenol, 4,4′thiodiphenol, 4,4′-sufonyldiphenol, 4,4′sulfinyldiphenol, 4,4′-hexafluoroisoproylidene)bisphenol (Bisphenol AF), 4,4′(1-phenylethylidene)bisphenol (Bisphenol AP), bis(4-hydroxyphenyl)-2,2-dichloroethylene (Bisphenol C). Bis(4-hydroxyphenyl)methane (Bisphenol-F), 4,4′-(cyclopentylidene)diphenol, 4,4′-(cyclohexylidene)diphenol (Bisphenol Z), 4,4′-(cyclododecylidene)diphenol 4,4′-(bicyclo[2.2.1]heptylidene)diphenol, 4,4′-(9H-fluorene-9,9-diyl)diphenol, isopropylidenebis(2-allylphenol), 3,3-bis(4-hydroxyphenyl)isobenzofuran-1(3H)-one, 1-(4-hydroxyphenyl)-3,3-dimethyl-2,3-dihydro-1H-inden-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tetrakis(4-hydroxyphenyl)ethane dicyclopentadienylbis(2,6-dimethyl phenol), dicyclopentadienyl bis(ortho-cresol), dicyclopentadienyl bisphenol, and the like.

The aldehyde used to form the benzoxazine may be any aldehyde. In some aspects, the aldehyde has 1-10 carbon atoms. In some aspects, the aldehyde is formaldehyde. The amine used to form the benzoxazine may be an aromatic amine, an aliphatic amine, an alkyl substituted aromatic, or an aromatic substituted alkyl amine. The amine may also be a polyamine, although the use of polyamines will, under some circumstances, yield polyfunctional benzoxazine monomers. Polyfunctional benzoxazine monomers are more likely to result in branched and/or crosslinked polybenzoxazines than monofunctional benzoxazines, which would be anticipated to yield thermoplastic polybenzoxazines.

The amines for forming benzoxazines generally have 1-40 carbon atoms unless they include aromatic rings, and then they may have 6-40 carbon atoms. The amine of di- or polyfunctional may also serve as a branch point to connect one polybenzoxazine to another. Thermal polymerization has been the preferred method for polymerizing benzoxazine monomers. The temperature to induce thermal polymerization is typically varied from 150-300° C. The polymerization is typically done in bulk, but could be done from solution or otherwise.

Catalysts, such as carboxylic acids, have been known to slightly lower the polymerization temperature or accelerate the polymerization rate at the same temperature.

The auxiliary curable resin may be a vinylbenzyl ether resin. Vinyl benzyl ether resins may be readily prepared from condensation of a phenol with a vinyl benzyl halide, such as vinylbenzyl chloride to produce a vinylbenzyl ether. Bisphenol-A and trisphenols and polyphenols are generally used to produce poly(vinylbenzyl ethers) which may be used to produce crosslinked thermosetting resins. Vinyl benzyl ethers useful in the present composition may include those vinylbenzyl ethers produced from reaction of vinylbenzyl chloride or vinylbenzyl bromide with resorcinol, catechol, hydroquinone, 2,6-dihydroxy naphthalene, 2,7-dihydroxynapthalene, 2-(diphenylphosphoryl)hydroquinone, bis(2.6-dimethylphenol) 2,2′-biphenol, 4.4-biphenol, 2.2′,6,6′-tetramethylbiphenol, 2,2′,3.3′0,6,6′-hexamethylbiphenol, 3,3′,5,5′-tetrabromo-2,2′6,6′-tetramethylbiphenol, 3,3′-dibromo-2,2′0,6,6′-tetramethylbiphenol, 2,2′,6,6′-tetramethyl-3,3′5-dibromobiphenol, 4,4′-isopropylidenediphenol (bisphenol A), 4,4′-isopropylidenebis(2,6-dibromophenol) (tetrabromobisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′(1,3-phenylenediisopropylidene)bisphenol (bisphenol M), 4,4′-isopropylidenebis(3-phenylphenol) 4,4′-(1.4-phenylenediisoproylidene)bisphenol (bisphenol P), 4,4′-ethylidenediphenol (bisphenol E), 4,4′oxydiphenol, 4,4′thiodiphenol, 4,4′thiobis(2,6-dimethylphenol), 4,4′-sufonyldiphenol, 4,4′-sufonylbis(2,6-dimethylphenol) 4,4′sulfonyldiphenol, 4,4′-hexafluoroisoproylidene)bisphenol (Bisphenol AF), 4,4′(1-phenylethylidene)bisphenol (Bisphenol AP), bis(4-hydroxyphenyl)-2,2-dichloroethylene (Bisphenol C), bis(4-hydroxyphenyl)methane (Bisphenol-F), bis(2.6-dimethyl-4-hydroxyphenyl)methane, 4,4′-(cyclopentylidene)diphenol, 4,4′-(cyclohexylidene)diphenol (Bisphenol Z), 4,4′-(cyclododecylidene)diphenol 4,4′-(bicyclo[2.2.1]heptylidene)diphenol, 4.4′-(9H-fluorene-9.9-diyl)diphenol, 3,3-bis(4-hydroxyphenyl)isobenzofuran-1(3H)-one, 1-(4-hydroxyphenyl)-3,3-dimethyl-2.3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3.3′-tetrahydro-1,1′-spirobi[indene]-5.6′-diol (Spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, bis(4-hydroxyphenyl)phenylphosphine oxide, dicyclopentadienylbis(2,6-dimethyl phenol), dicyclopentadienyl bis(ortho-cresol), dicyclopentadienyl bisphenol, and the like.

The auxiliary curable resin may be an arylcyclobutene resin. Arylcyclobutenes include those derived from compounds of the general structure

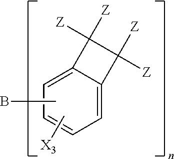

wherein B is an organic or inorganic radical of valence n (including carbonyl, sulfonyl, sulfinyl, sulfide, oxy, alkylphosphonyl, arylphosphonyl, isoalkylidene, cycloalkylidene, arylalkylidene, diarylmethylidene, methylidene dialkylsilanyl, arylalkylsilanyl, diarylsilanyl and C₆₋₂₀ phenolic compounds); each occurrence of X independently comprises hydroxy or C₁₋₂₄ hydrocarbyl (including linear and branched alkyl and cycloalkyl); and each occurrence of Z independently comprises hydrogen, halogen, or C₁₋₁₂ hydrocarbyl; and n is 1-1000, or 1-8, or 2, 3, or 4. Other useful arylcyclobutenes and methods of arylcyclobutene synthesis may be found in U.S. Pat. Nos. 4,743,399, 4,540,763, 4,642,329, 4,661,193, and 4,724,260 to Kirchhoff et al., and 5,391,650 to Brennan et al.

The auxiliary curable resin may include an isocyanate resin. Examples include but are not limited to 1,4-cyclohexane diisocyanate, isophorone diisocyanate, methylene bis(4-cyclohexylisocyanate), triallyl isocyanurate (TAIC), hydrogenated 1,3-xylylene diisocyanate and hydrogenated 1,4-xylylene diisocyanate.

The auxiliary curable resin may be a perfluorovinyl ether resin. Perfluorovinyl ethers are typically synthesized from phenols and bromotetrafluoroethane followed by zinc catalyzed reductive elimination producing ZnFBr and the desired perfluorovinylether. By this route bis, tris, and other polyphenols may produce bis-, tris- and poly(perfluorovinylether)s.

Non-limiting examples of phenols useful in their synthesis include resorcinol, catechol, hydroquinone, 2,6-dihydroxy naphthalene, 2,7-dihydroxynapthalene, 2-(diphenylphosphoryl)hydroquinone, bis(2,6-dimethylphenol) 2,2′-biphenol, 4,4-biphenol. 2,2′0,6,6′-tetramethylbiphenol, 2,2′,3,3′,6.6′-hexamethylbiphenol, 3,3′,5,5′-tetrabromo-2.2′6,6′-tetramethylbiphenol, 3,3′-dibromo-2,2′0,6,6′-tetramethylbiphenol, 2,2′,6,6′-tetramethyl-3,3′5-dibromobiphenol, 4.4′-isopropylidenediphenol (bisphenol A), 4,4′-isopropylidenebis(2,6-dibromophenol) (tetrabromobisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4.4′(1,3-phenylenediisopropylidene)bisphenol (bisphenol M), 4.4′-isopropylidenebis(3-phenylphenol) 4,4′-(1.4-phenylenediisoproylidene)bisphenol (bisphenol P), 4,4′-ethylidenediphenol (bisphenol E), 4,4′oxydiphenol, 4,4′thiodiphenol, 4,4′thiobis(2,6-dimethylphenol), 4.4′-sufonyldiphenol, 4.4′-sufonylbis(2,6-dimethylphenol) 4.4′sulfinyldiphenol, 4,4′-hexafluoroisoproylidene)bisphenol (Bisphenol AF), 4,4′(1-phenylethylidene)bisphenol (Bisphenol AP), bis(4-hydroxyphenyl)-2,2-dichloroethylene (Bisphenol C), bis(4-hydroxyphenyl)methane (Bisphenol-F), bis(2.6-dimethyl-4-hydroxyphenyl)methane, 4,4′-(cyclopentylidene)diphenol, 4,4′-(cyclohexylidene)diphenol (Bisphenol Z), 4,4′-(cyclododecylidene)diphenol 4,4′-(bicyclo[2.2.1]heptylidene)diphenol, 4,4′-(9H-fluorene-9,9-diyl)diphenol, 3,3-bis(4-hydroxyphenyl)isobenzofuran-1(3H)-one, 1-(4-hydroxyphenyl)-3,3-dimethyl-2.3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3.5-dimethyl-4-hydroxyphenyl)ethane, bis(4-hydroxyphenyl)phenylphosphine oxide, dicyclopentadienylbis(2,6-dimethyl phenol), dicyclopentadienyl bis(2-methylphenol), dicyclopentadienyl bisphenol, and the like.

The curable composition may include an oligomer or polymer with curable vinyl functionality. Such materials include oligomers and polymers having crosslinkable unsaturation. Examples include styrene butadiene rubber (SBR), butadiene rubber (BR), and nitrile butadiene rubber (NBR) having unsaturated bonding based on butadiene; natural rubber (NR), isoprene rubber (IR), chloroprene rubber (CR), butyl rubber (a copolymer of isobutylene and isoprene, IIR), and halogenated butyl rubber having unsaturated bonding based on isoprene; ethylene-α-olefin copolymer elastomers having unsaturated bonding based on dicyclopentadiene (DCPD), ethylidene norbornene (ENB), or 1,4-dihexadiene (1,4-HD) (namely, ethylene-α-olefin copolymers obtained by copolymerizing ethylene, an α-olefin, and a diene, such as ethylene-propylene-diene terpolymer (EPDM) and ethylene-butene-diene terpolymer (EBDM). In some aspects, an EBDM is used. Examples also include hydrogenated nitrile rubber, fluorocarbon rubbers such as vinylidenefluoride-hexafluoropropene copolymer and vinylidenefluoride-pentafluoropropene copolymer, epichlorohydrin homopolymer (CO), copolymer rubber (ECO) prepared from epichlorohydrin and ethylene oxide, epichlorohydrin allyl glycidyl copolymer, propylene oxide allyl glycidyl ether copolymer, propylene oxide epichlorohydrin allyl glycidyl ether terpolymer, acrylic rubber (ACM), urethane rubber (U), silicone rubber (Q), chlorosulfonated polyethylene rubber (CSM), polysulfide rubber (T) and ethylene acrylic rubber. Further examples include various liquid rubbers, for example various types of liquid butadiene rubbers, and the liquid atactic butadiene rubber that is butadiene polymer with 1,2-vinyl connection prepared by anionic living polymerization. It is also possible to use liquid styrene butadiene rubber, liquid nitrile butadiene rubber (CTBN, VTBN, ATBN, etc. by Ube Industries, Ltd.), liquid chloroprene rubber, liquid polyisoprene, dicyclopentadiene type hydrocarbon polymer, and polynorbornene (for example, as sold by ELF ATOCHEM).

Polybutadiene resins, generally polybutadienes containing high levels of 1,2 addition may be desirable in curable compositions. Examples include the functionalized polybutadienes and poly(butadiene-styrene) random copolymers sold by RICON RESINS, Inc. under the trade names RICON, RICACRYL, and RICOBOND resins. These include butadienes containing both low vinyl content such as RICON 130, 131, 134, 142; polybutadienes containing high vinyl content such as RICON 150, 152, 153, 154, 156, 157, and P30D; random copolymers of styrene and butadiene including RICON 100, 181, 184, and maleic anhydride grafted polybutadienes and the alcohol condensates derived therefrom such as RICON 130MA8. RICON MA13, RICON 130MA20, RICON 131MAS, RICON 131MA10, RICON MA17. RICON MA20, RICON 184MA6 and RICON 156MA17. Also included are polybutadienes that may be used to improve adhesion including RICOBOND 1031, RICOBOND 1731, RICOBOND 2031, RICACRYL 3500, RICOBOND 1756, RICACRYL 3500; the polybutadienes RICON 104 (25% polybutadiene in heptane), RICON 257 (35% polybutadiene in styrene), and RICON 257 (35% polybutadiene in styrene); (meth)acrylic functionalized polybutadienes such as polybutadiene diacrylates and polybutadiene dimethacrylates. These materials are sold under the tradenames RICACRYL 3100, RICACRYL 3500, and RICACRYL 3801. Also are included are powder dispersions of functional polybutadiene derivatives including, for example, RICON 150D, 152D, 153D, 154D, P3OD, RICOBOND 0 1731 HS, and RICOBOND 1756HS. Further butadiene resins include poly(butadiene-isoprene) block and random copolymers, such as those with molecular weights from 3,000-50,000 grams per mole and polybutadiene homopolymers having molecular weights from 3.000-50,000 grams per mole. Also included are polybutadiene, polyisoprene, and polybutadiene-isoprene copolymers functionalized with maleic anhydride functions, 2-hydroxyethylmaleic functions, or hydroxylated functionality.

Further examples of oligomers and polymers with curable vinyl functionality include unsaturated polyester resins based on maleic anhydride, fumaric acid, itaconic acid and citraconic acid; unsaturated epoxy (meth)acrylate resins containing acryloyl groups, or methacryloyl group; unsaturated epoxy resins containing vinyl or allyl groups, urethane (meth)acrylate resin, polyether (meth)acrylate resin, polyalcohol (meth)acrylate resins, alkyd acrylate resin, polyester acrylate resin, spiroacetal acrylate resin, diallyl phthalate resin, diallyl tetrabromophthalate resin, diethyleneglycol bisallylcarbonate resin, and polyethylene polythiol resin.

In some aspects, the curable composition comprises a curable unsaturated monomer or polymer composition. The curable unsaturated monomer composition may include, for example, a monofunctional styrenic compound (e.g., styrene), a monofunctional (meth)acrylic compound, a polyfunctional allylic compound, a polyfunctional (meth)acrylate, a polyfunctional (meth)acrylamide, a polyfunctional styrenic compound, or a combination thereof.

For example, in some aspects, the curable unsaturated monomer composition may be an alkene-containing monomer or an alkyne-containing monomer. Exemplary alkene- and alkyne-containing monomers include those described in U.S. Pat. No. 6,627,704 to Yeager et al. Non-limiting examples of alkene-containing monomers include acrylate, methacrylate, and vinyl ester functionalized materials capable of undergoing free radical polymerization. Of particular use are acrylate and methacrylate materials. They may be monomers and/or oligomers such as (meth)acrylates, (meth)acrylamides, N-vinylpyrrolidone and vinylazalactones as disclosed in U.S. Pat. No. 4,304,705 of Heilman et al. Such monomers include mono-, di-, and polyacrylates and methacrylates, such as methyl acrylate, methyl methacrylate, ethyl acrylate, isopropyl methacrylate, isooctyl acrylate, isobornyl acrylate, isobornyl methacrylate, acrylic acid, n-hexyl acrylate, tetrahydrofurfuryl acrylate, N-vinylcaprolactam, N-vinylpyrrolidone, acrylonitrile, stearyl acrylate, allyl acrylate, glycerol diacrylate, glycerol triacrylate, ethylene glycol diacrylate, diethylene glycol diacrylate, triethylene glycol dimethacrylate, 1.6-hexanediol diacrylate, 1,3-propanediol diacrylate, 1,3-propanediol dimethacrylate, trimethylolpropane triacrylate, 1,2,4-butanetriol trimethacrylate, 2-phenoxyethyl acrylate, 1,4-cyclohexanediol diacrylate, pentaerythritol triacrylate, pentaerythritol tetraacrylate, pentaerythritol tetramethacrylate, sorbitol hexaacrylate, bis[1-(2-acryloxy)]-p-ethoxyphenyldimethylmethane, 2,2-bis[1-(3-acryloxy-2-hydroxy)]propoxyphenylpropane, tris(hydroxyethyl)isocyanurate trimethacrylate; the bis-acrylates and bis-methacrylates of polyethylene glycols of molecular weight average 200-500 grams per mole, bis-acrylates and bis-methacrylates of polybutadienes of molecular weight average 1000-10,000 grams per mole, copolymerizable mixtures of acrylated monomers such as those disclosed in U.S. Pat. No. 4,652,274 to Boettcher et al, and acrylated oligomers such as those disclosed in U.S. Pat. No. 4,642,126 to Zador et al.

It may be desirable to crosslink the alkene- or alkyne-containing monomer. Particularly useful as crosslinker compounds are acrylates such as allyl acrylate, glycerol diacrylate, glycerol triacrylate, ethylene glycol diacrylate, diethylene glycol diacrylate, triethylene glycol dimethacrylate, 1,6-hexanediol diacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexaacrylate, bis[1-(2-acryloxy)]-p-ethoxyphenyldi-methylmethane, 2,2-bis[1-(3-acryloxy-2-hydroxy)]propoxyphenylpropane, tris(hydroxyethyl)isocyanurate trimethacrylate; and the bis-acrylates and bis-methacrylates of polyethylene glycols of average molecular weight 200-500 grams per mole.

Also included are allylic resins and styrenic resins for example triallylisocyanurate and trimethallylisocyanurate, trimethallylcyanurate, triallylcyanurate, divinyl benzene and dibromostyrene and others described in U.S. Pat. No. 6,627,704 to Yeager et al.

In addition to the poly(arylene ether), the curing promoter, and, when present, the auxiliary resin or unsaturated monomer composition, the curable composition can, optionally, comprise a solvent. The solvent may have an atmospheric boiling point of 50 to 250° C. A boiling point in this range facilitates removal of solvent from the curable composition while minimizing or eliminating the effects of bubbling during solvent removal.

The solvent may be, for example, a C₃₋₈ ketone, a C₃₋₈ N,N-dialkylamide, a C₄0.16 dialkyl ether, a C₆₋₁₂ aromatic hydrocarbon, a C₁₋₃ chlorinated hydrocarbon, a C₃₋₆ alkyl alkanoate, a C₂₋₆ alkyl cyanide, or a combination thereof. The carbon number ranges refer to the total number of carbon atoms in the solvent molecule. For example, a C₄₋₁₆ dialkyl ether has 4 to 16 total carbon atoms, and the two alkyl groups may be the same or different. As other examples, the 3-8 carbon atoms in the “N,N-dialkylamide” include the carbon atom in the amide group, and the 2-6 carbons in the “C₂₋₆ alkyl cyanides” include the carbon atom in the cyanide group. Specific ketone solvents include, for example, acetone, methyl ethyl ketone, methyl isobutyl ketone, or a combination thereof. Specific C₄₋₈ NN-dialkylamide solvents include, for example, dimethylformamide, dimethylacetamide, N-methyl-2-pyrrolidone, or a combination thereof. Specific dialkyl ether solvents include, for example, tetrahydrofuran, ethylene glycol monomethylether, dioxane, or a combination thereof. In some aspects, the C₄₋₁₆ dialkyl ethers include cyclic ethers such as tetrahydrofuran and dioxane. In some aspects, the C₄₋₁₆ dialkyl ethers are noncyclic. The dialkyl ether can, optionally, further include one or more ether oxygen atoms within the alkyl groups and one or more hydroxy group substituents on the alkyl groups. The aromatic hydrocarbon solvent may comprise an ethylenically unsaturated solvent. Exemplary aromatic hydrocarbon solvents include, for example, benzene, toluene, xylenes, styrene, divinylbenzenes, or a combination thereof. The aromatic hydrocarbon solvent is preferably non-halogenated. As used herein, the term “non-halogenated” means that the solvent does not include any fluorine, chlorine, bromine, or iodine atoms. Specific C₃ alkyl alkanoates include, for example, methyl acetate, ethyl acetate, methyl propionate, ethyl propionate, or a combination thereof. Specific C₂_alkyl cyanides include, for example, acetonitrile, propionitrile, butyronitrile, or a combination thereof. In some aspects, the solvent is acetone. In some aspects, the solvent is methyl ethyl ketone. In some aspects, the solvent is methyl isobutyl ketone. In some aspects, the solvent is N-methyl-2-pyrrolidone. In some aspects, the solvent is dimethylformamide. In some aspects, the solvent is ethylene glycol monomethyl ether.

When a solvent is utilized, the curable composition may comprise 2-100 parts by weight of the solvent, based on 100 parts by weight total of the poly(arylene ether), the curing promoter, and the auxiliary resin or unsaturated monomer composition (when present). For example, the solvent amount may be 5-80 parts by weight, or 10-60 parts by weight, or 20-40 parts by weight, based on 100 parts by weight total of the poly(arylene ether), the curing promoter, and any auxiliary resin. The solvent may be chosen, in part, to adjust the viscosity of the curable composition. Thus, the solvent amount may depend on variables including the type and amount of poly(arylene ether), the type and amount of curing promoter, the type and amount of auxiliary resin, and the processing temperature used for any subsequent processing of the curable composition, for example, impregnation of a reinforcing structure with the curable composition for the preparation of a composite.

The curable composition can, optionally, further comprise one or more additives. Exemplary additives include, for example, solvents, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, inorganic fillers, or a combination thereof.

The curable composition may comprise the poly(arylene ether) described herein, a curing promoter, a solvent, and an auxiliary resin, a curable unsaturated monomer or polymer composition, or a combination thereof. In some aspects, an auxiliary curable resin and/or a curable unsaturated monomer or polymer composition is absent.

The curable composition may comprise 1-99 wt % of the auxiliary curable resin, a curable unsaturated monomer or polymer composition, or both and 1-99 wt % of the poly(arylene ether), each based on the total weight of the curable composition. For example, the composition may include 20-99 wt % of the auxiliary curable resin, a curable unsaturated monomer or polymer composition, or both and 1-80 wt % of the poly(arylene ether)).

A thermoset composition (i.e., cured composition) may be obtained using any curing method known in the art, for example, moisture curing, thermal curing, and/or UV curing. In some aspects, the thermosets may be obtained by heating the curable composition defined herein for a time and temperature sufficient to evaporate the solvent and effect curing. For example, the curable composition may be heated to a temperature of 50-250° C. to cure the composition and provide the thermoset composition. In curing, a cross-linked, three-dimensional polymer network is formed. For certain thermoset resins, for example (meth)acrylate resins, curing may also take place by irradiation with actinic radiation at a sufficient wavelength and time. In some aspects, curing the composition may include injecting the curable composition into a mold, and curing the injected composition at 150-250° C. in the mold.

The thermoset composition described herein may also be particularly well suited for use in forming various articles. For example, useful articles may be in the form of a composite, a foam, a fiber, a layer, a coating, an encapsulant, an adhesive, a sealant, a molded component, a prepreg, a casing, a laminate, a metal clad laminate, an electronic composite, a structural composite, or a combination thereof. In some aspects, the article may be in the form of a composite that may be used in a variety of applications, for example printed circuit boards.

The sizing agent may also be used as a coating for reinforcing agents, for example sized reinforcing agents. Possible sized reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well a combination thereof. The fillers and reinforcing agents may be coated with a layer of metallic material to facilitate conductivity, or surface treated with silanes to improve adhesion and dispersion with the polymer matrix.

The sizing agent may also be used as a coating for a metallic foil, for example a copper foil. The metallic foils may be characterized by surface roughness (Rz). Rz measures the vertical distance from the highest peak to the lowest valley within five sampling lengths and averages the distances. Rz may be measured using a contact profilometer or with light interferometry, according to ASTM D7127, ISO 25178, or a combination thereof.

The metallic foil may include a standard surface. The foil roughness may be about 10.2 μm or greater as determined according to Rz ISO or about 8.5 μm or greater as determined according to Rz JIS for a foil having a 35 μm thickness.

The metallic foil may have a smooth surface as classified by IPC-4562. The metallic foil may include a low-profile metallic foil. The foil roughness may range from about 5.1 to about 10.2 μm as determined according to Rz ISO or from about 4.2 μm to about 8.5 μm determined according to Rz JIS for a foil having a 35 μm thickness. The metallic foil may include a very low-profile metallic foil. The foil roughness may range from about 2.5 to about 5.1 μm as determined according to Rz ISO or from about 2.0 μm to about 4.2 μm determined according to Rz JIS for a foil having a 35 μm thickness. The metallic foil may include an ultra-flat profile metallic foil. The foil roughness may range from about 1.25 to about 10.2 μm as determined according to Rz ISO or from about 4.2 μm to about 8.5 μm determined according to Rz JIS for a foil having a 35 μm thickness. The metallic foil may include an almost no profile metallic foil. The foil roughness may range from about 0 to about 1.25 μm as determined according to Rz ISO or from about 0 μm to about 1.25 μm determined according to Rz JIS for a foil having a 35 μm thickness.

The metallic foil may have a thickness from about 10 μm to about 100 μm, from about 10 μm to about 75 μm, or from about 10 μm about 50 μm. In some aspects, the metallic foil has a thickness of about 15 μm to above 40 μm.

This disclosure is further illustrated by the following examples, which are non-limiting.

### Examples

Redistribution of 2-allyl-6-methyl phenol to poly(phenylene ether): 120 grams of poly(phenylene ether) was added to a 1 L 4-neck round bottom flask equipped with condenser, thermocouple, heating mantle, overhead agitator, and addition port, 170 mL toluene was added to the reaction flask and poly(phenylene ether) was dissolved under stirring under N₂ atmosphere. To this solution, 6.61 g of 2-allyl-6-methyl phenol was added (44.6 mmol) and the temperature was set to 100° C. At 60-80° C., 3.81 g of benzoyl peroxide (15.8 mmol) was added.

The reaction temperature was maintained at 100° C. for 3.5 h. The reaction mixture was cooled down to ambient temperature under N₂.

Hydrosilylation of 2-allyl-6-methyl phenol containing poly(phenylene ether): To the above reaction flask added 60 ml toluene. A Dean-Stark trap was attached to the flask and the temperature raised to obtain a vigorous reflux. After removal of 60 mL azeotropic mixture, the reaction solution was cooled down to 100° C., 7.33 g triethoxysilane (44.6 mmol) and 0.66 g Karstedt's Catalyst (0.69 mmol) were added to the reaction solution and refluxed for 4.5 h. The solvent was removed using rotary evaporator and the product was further dried in vacuum oven overnight at 90° C. The product was analyzed by ¹H NMR spectroscopy, which confirmed the presence of the silyl-containing group. ¹H NMR (600 MHz, CDCl₃): (1) δ 1.18 (9H, t); (2) δ 3.9 (6H, q); (3) δ 0.9 (2H, t); (4) δ 1.6 (2H, m); (5) δ 2.5 (2H, t).

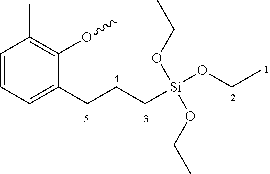

Redistribution of eugenol to poly(phenylene ether): 120 grams of poly(phenylene ether) was added to a 2 L 3-neck round bottom flask equipped with condenser, thermocouple, heating mantle, overhead agitator, and addition port, 170 mL toluene was added to the reaction flask and poly(phenylene ether) was dissolved under stirring under N₂ atmosphere. To this solution, 7.3 g eugenol (44.6 mmol) was added (44.6 mmol) and the temperature was set to 100° C. At 60-80° C., 3.81 g of benzoyl peroxide (15.8 mmol) was added. The reaction temperature was maintained at 100° C. for 3.5 h. The reaction mixture was cooled down to ambient temperature under N₂.

Hydrosilylation of eugenol containing poly(phenylene ether): To the above reaction flask added 60 ml toluene. A Dean-Stark trap was attached to the flask and the temperature raised to obtain a vigorous reflux. After removal of 60 mL azeotropic mixture, the reaction solution was cooled down to 100° C., 7.33 g triethoxysilane (44.6 mmol) and 0.66 g Karstedt's Catalyst (0.69 mmol) were added to the reaction solution and refluxed for 4.5 h. The solvent was removed using rotary evaporator and the product was further dried in vacuum oven overnight at 90° C. The product was analyzed by ¹H NMR spectroscopy, which confirmed the presence of the silyl-containing group. ¹H NMR (600 MHz, CDCl₃):): (1) δ 1.18 (9H, t); (2) δ 3.9 (6H, q); (3) δ 0.9 (2H, t); (4) δ 1.6 (2H, m); (5) δ 2.5 (2H, t).

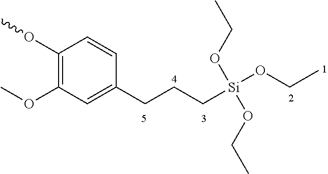

This disclosure further encompasses the following aspects.

Aspect 1. A composition comprising a sizing agent comprising a bifunctional poly(arylene ether) comprising a silyl-containing group comprising a silyl-containing terminal group, a silyl-containing pendant group, or a combination thereof; and optionally comprising a terminal functional group, wherein the terminal functional group is not a silyl-containing terminal group or hydrogen.

Aspect 2. The composition of Aspect 1, further comprising an auxiliary monofunctional or bifunctional poly(arylene ether) optionally comprising at least one terminal functional group, wherein the at least one terminal functional group is not a silyl-containing terminal group or hydrogen.

Aspect 3. The composition of any one of the preceding aspects, wherein the silyl-containing terminal group comprises the formula

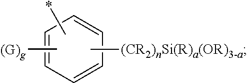

the silyl-containing pendant group comprises the formula (CR₂)ₙSi(Rₐ)(OR)₃₋ₐ, wherein the silyl-containing pendant group is derived from a repeating unit comprising the formula

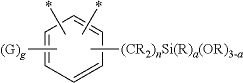

wherein each occurrence of R is independently hydrocarbyl, a is 0 to 2, n is 2 to 13, g is 0 to 4, each occurrence of G is halogen, unsubstituted or substituted C₁₋₁₅ primary or secondary hydrocarbyl, C₁₋₁₅ hydrocarbylthio, C₁₋₁₅ is hydrocarbyloxy, or C₂₋₁₅ halohydrocarbyloxy wherein at least two carbon atoms separate the halogen and oxygen atoms, and * indicates attachment to the poly(arylene ether) via a carbon-oxygen bond.

Aspect 4. The composition of any one of the preceding aspects, wherein the terminal functional group of the bifunctional poly(arylene ether) of the sizing agent and the at least one terminal functional group of the auxiliary monofunctional or bifunctional poly(arylene ether) each independently comprise (meth)acrylate, styrene, —CH₂—(C₆H₄)—CH═CH₂, allyl, a cyanate ester, a glycidyl ether, an anhydride, an aniline, a maleimide, or an activated ester.

Aspect 5. The composition of any one of the preceding aspects comprising a sizing agent comprising a bifunctional poly(arylene ether) having a silyl-containing group comprising a silyl-containing terminal group, a silyl-containing pendant group, or a combination thereof; and optionally, at least one terminal functional group, wherein the at least one terminal functional group is not a silyl-containing terminal group or hydrogen, and an auxiliary monofunctional or bifunctional poly(arylene ether) having at least one terminal functional group, wherein the at least one terminal functional group is not a silyl-containing terminal group or hydrogen, wherein the silyl-containing terminal group comprises the formula

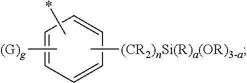

and the silyl-containing terminal group comprises the formula (CR₂)ₙSi(Rₐ)(OR)₃₋ₐ, wherein the silyl-containing pendant group is derived from a repeating unit comprising the formula

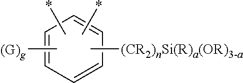

wherein each occurrence of R is independently hydrocarbyl, a is 0 to 2, n is 2 to 13, g is 0 to 4, each occurrence of G is halogen, unsubstituted or substituted C₁₋₁₅ primary or secondary hydrocarbyl, C₁₋₁₅ hydrocarbylthio, C₁₋₁₅ hydrocarbyloxy, or C₂₋₁₅ halohydrocarbyloxy wherein at least two carbon atoms separate the halogen and oxygen atoms, and * indicates attachment to the poly(arylene ether) via a carbon-oxygen bond.

Aspect 6. A method of making the sizing agent of any one of the preceding aspects comprising oxidatively polymerizing a monohydric phenol, an alkenyl-substituted monohydric phenol, and optionally a dihydric phenol to provide a sizing agent precursor having an alkenyl pendant group, an alkenyl-substituted phenolic terminal functional group, or a combination thereof, and a bifunctional poly(arylene ether) having at least one hydroxyl terminus, reacting the alkenyl group of the sizing agent precursor with a silane reagent to provide a sizing agent having a silyl-containing terminal group, a silyl-containing pendant group, or a combination thereof, and at least one hydroxyl terminus, and optionally reacting the at least one hydroxyl terminus of the sizing agent to provide a sizing agent having a silyl-containing terminal group, a silyl-containing pendant group, or a combination thereof and a terminal functional group, wherein the terminal functional group is not a silyl-containing terminal group or hydrogen, and optionally reacting an at least one hydroxyl terminus of the bifunctional poly(arylene ether) to provide a bifunctional poly(arylene ether) having the at least one terminal functional group.

Aspect 7. A method of making sizing agent of any one of the preceding aspects comprising adding a redistribution catalyst to a reaction mixture comprising an alkenyl-substituted monohydric phenol and a bifunctional poly(arylene ether) precursor having at least one hydroxyl terminus to provide a sizing agent oligomeric precursor having an alkenyl-substituted phenolic terminal functional group and a monofunctional or bifunctional poly(arylene ether) having a hydroxyl terminus, reacting the alkenyl group of the sizing agent oligomeric precursor with a silane reagent to provide a sizing agent having a hydroxyl terminus and a silyl-containing terminal group, and optionally reacting the hydroxyl terminus of the sizing agent oligomeric precursor to provide a sizing agent having a silyl-containing terminal group and a terminal functional group, wherein the terminal functional group is not a silyl-containing terminal group or hydrogen, and optionally reacting the hydroxyl terminus of the monofunctional or bifunctional poly(arylene ether) to provide a bifunctional poly(arylene ether) having a terminal functional group.

Aspect 8. A method of making sizing agent of any one of the preceding aspects comprising adding a redistribution catalyst to a reaction mixture comprising a silyl-substituted monohydric phenol and a bifunctional poly(arylene ether) precursor having a hydroxyl terminus to provide a sizing agent oligomeric precursor having a silyl-substituted phenolic terminal functional group and a bifunctional poly(arylene ether) having a hydroxyl terminus; and optionally reacting the hydroxyl terminus of the sizing agent oligomeric precursor having a silyl-substituted phenolic terminal functional group to provide a sizing agent having a silyl-containing terminal group and a terminal functional group, wherein the terminal functional group is not a silyl-containing terminal group or hydrogen, and optionally reacting the hydroxyl terminus of the bifunctional poly(arylene ether) to provide a monofunctional or bifunctional poly(arylene ether) having a terminal functional group.

Aspect 9. A curable composition comprising the composition of any one of aspects 2 to 6, wherein the bifunctional poly(arylene ether) of the sizing agent and the auxiliary monofunctional or bifunctional poly (arylene ether) each comprise a terminal functional group; and optionally, a curing promoter.

Aspect 10. The curable composition of Aspect 9, further comprising an auxiliary curable resin, a curable unsaturated monomer or polymer, or a combination thereof.

Aspect 11. A thermoset composition comprising the curable composition of Aspect 9 or Aspect 10.

Aspect 12. A method of forming a coated substrate comprising providing a substrate, coating the substrate with the curable composition of one of Aspects 8-9 to provide a coated substrate, and curing the curable composition, wherein the curing comprises moisture curing, thermal curing, or UV curing.

Aspect 13. An article comprising the thermoset composition of Aspect 12, wherein the article is a composite, a foam, a fiber, a layer, a coating, an encapsulant, an adhesive, a sealant, a molded component, a prepreg, a casing, a laminate, a metal clad laminate, an electronic composite, or a structural composite, preferably an adhesive, a prepreg, a laminate, or a metal clad laminate.

Aspect 14. A reinforcing agent sized with the composition of any one of Aspects 1-10.

Aspect 15. A metallic foil coated with the composition of any one of Aspects 1-10.

The compositions, methods, and articles may alternatively comprise, consist of, or consist essentially of, any appropriate materials, steps, or components herein disclosed. The compositions, methods, and articles may additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspects”, “an aspect”, and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O-), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups may be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that may each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄O₂—), a C₃₋₁₂ cycloalkyl, a C₂₋₁ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising a sizing agent comprising a bifunctional poly(arylene ether) comprising
a silyl-containing group comprising a silyl-containing terminal group, a silyl-containing pendant group, or a combination thereof; and
optionally comprising a terminal functional group, wherein the terminal functional group is not a silyl-containing terminal group or hydrogen.

2. The composition of claim 1, further comprising an auxiliary monofunctional or bifunctional poly(arylene ether) optionally comprising at least one terminal functional group, wherein the at least one terminal functional group is not a silyl-containing terminal group or hydrogen.

3. The composition of claim 1, wherein
the silyl-containing terminal group comprises the formula 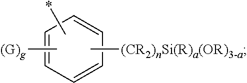
the silyl-containing pendant group comprises the formula
(CR₂)ₙSi(Rₐ)(OR)₃₋ₐ, wherein the silyl-containing pendant group is derived from a repeating unit comprising the formula 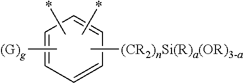
wherein each occurrence of R is independently hydrocarbyl, a is 0 to 2, n is 2 to 13, g is 0 to 4, each occurrence of G is halogen, unsubstituted or substituted C₁₋₁₅ primary or secondary hydrocarbyl, C₁₋₁₅ hydrocarbylthio, C₁₋₁₅ hydrocarbyloxy, or C₂₋₁₅ halohydrocarbyloxy wherein at least two carbon atoms separate the halogen and oxygen atoms, * indicates attachment to the poly(arylene ether) via a carbon-oxygen bond.

4. The composition of claim 1, wherein the terminal functional group of the bifunctional poly(arylene ether) of the sizing agent and the at least one terminal functional group of the auxiliary monofunctional or bifunctional poly(arylene ether) each independently comprise (meth)acrylate, styrene, —CH₂—(C₆H₄)—CH═CH₂, allyl, a cyanate ester, a glycidyl ether, an anhydride, an aniline, maleimide, or an activated ester.

5. The composition of claim 1 comprising
a sizing agent comprising
a bifunctional poly(arylene ether) having a silyl-containing group comprising a silyl-containing terminal group, a silyl-containing pendant group, or a combination thereof, and
optionally, at least one terminal functional group, wherein the at least one terminal functional group is not a silyl-containing terminal group or hydrogen, and
an auxiliary monofunctional or bifunctional poly(arylene ether) having at least one terminal functional group, wherein the at least one terminal functional group is not a silyl-containing terminal group or hydrogen,
wherein the silyl-containing terminal group comprises the formula 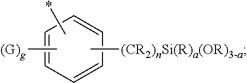
the silyl-containing pendant group comprises the formula (CR₂)ₙSi(Rₐ)(OR)₃₋ₐ, wherein the silyl-containing pendant group is derived from a repeating unit comprising the formula 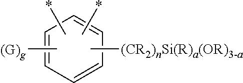
wherein each occurrence of R is independently hydrocarbyl, a is 0 to 2, n is 2 to 13, g is 0 to 4, each occurrence of G is halogen, unsubstituted or substituted C₁₋₁₅ primary or secondary hydrocarbyl, C₁₋₁₅ hydrocarbylthio, C₁₋₁₅ hydrocarbyloxy, or C₂₋₁₅ halohydrocarbyloxy wherein at least two carbon atoms separate the halogen and oxygen atoms, and * indicates attachment to the poly(arylene ether) via a carbon-oxygen bond.

6. A method of making the sizing agent of claim 1 comprising
oxidatively polymerizing a monohydric phenol, an alkenyl-substituted monohydric phenol, and optionally a dihydric phenol to provide a sizing agent precursor having an alkenyl pendant group, an alkenyl-substituted phenolic terminal functional group, or a combination thereof, and a monofunctional or bifunctional poly(arylene ether) having at least one hydroxyl terminus,
reacting the alkenyl group of the sizing agent precursor with a silane reagent to provide a sizing agent having a silyl-containing terminal group, a silyl-containing pendant group, or a combination thereof, and at least one hydroxyl terminus, and
optionally reacting the at least one hydroxyl terminus of the sizing agent to provide a sizing agent having a silyl-containing terminal group, a silyl-containing pendant group, or a combination thereof and a terminal functional group, wherein the terminal functional group is not a silyl-containing terminal group or hydrogen, and
optionally reacting an at least one hydroxyl terminus of the monofunctional or bifunctional poly(arylene ether) to provide a monofunctional or bifunctional poly(arylene ether) having the at least one terminal functional group.

7. A method of making sizing agent of claim 1 comprising
adding a redistribution catalyst to a reaction mixture comprising an alkenyl-substituted monohydric phenol and a bifunctional poly(arylene ether) precursor having at least one hydroxyl terminus to provide a sizing agent oligomeric precursor having an alkenyl-substituted phenolic terminal functional group and a monofunctional or bifunctional poly(arylene ether) having a hydroxyl terminus,
reacting the alkenyl group of the sizing agent oligomeric precursor with a silane reagent to provide a sizing agent having a hydroxyl terminus and a silyl-containing terminal group, and
optionally reacting the hydroxyl terminus of the sizing agent oligomeric precursor to provide a sizing agent having a silyl-containing terminal group and a terminal functional group, wherein the terminal functional group is not a silyl-containing terminal group or hydrogen, and
optionally reacting the hydroxyl terminus of the monofunctional or bifunctional poly(arylene ether) to provide a bifunctional poly(arylene ether) having a terminal functional group.

8. A method of making sizing agent of claim 1 comprising
adding a redistribution catalyst to a reaction mixture comprising a silyl-substituted monohydric phenol and a monofunctional or bifunctional poly(arylene ether) precursor having a hydroxyl terminus to provide a sizing agent oligomeric precursor having a silyl-substituted phenolic terminal functional group and a monofunctional or bifunctional poly(arylene ether) having a hydroxyl terminus; and
optionally reacting the hydroxyl terminus of the sizing agent oligomeric precursor having a silyl-substituted phenolic terminal functional group to provide a sizing agent having a silyl-containing terminal group and a terminal functional group, wherein the terminal functional group is not a silyl-containing terminal group or hydrogen, and
optionally reacting the hydroxyl terminus of the monofunctional or bifunctional poly(arylene ether) to provide a monofunctional or bifunctional poly(arylene ether) having a terminal functional group.

9. A curable composition comprising
the composition of claim 2, wherein the bifunctional poly(arylene ether) of the sizing agent and the auxiliary monofunctional or bifunctional poly (arylene ether) each comprise a terminal functional group; and
optionally, a curing promoter.

10. The curable composition of claim 9, further comprising an auxiliary curable resin, a curable unsaturated monomer or polymer, or a combination thereof.

11. A thermoset composition comprising the curable composition of claim 9.

12. A method of forming a coated substrate comprising providing a substrate,
coating the substrate with the curable composition of claim 9 to provide a coated substrate, and
curing the curable composition, wherein the curing comprises moisture curing, thermal curing, or UV curing.

13. An article comprising the thermoset composition of claim 12, wherein the article is a composite, a foam, a fiber, a layer, a coating, an encapsulant, an adhesive, a sealant, a molded component, a prepreg, a casing, a laminate, a metal clad laminate, an electronic composite, or a structural composite.

14. A reinforcing agent sized with the composition of claim 1.

15. A metallic foil coated with the composition of claim 1.

16. The article of claim 13, wherein the article is an adhesive, a prepreg, a laminate, or a metal clad laminate.
